(19) United States
(12) Patent Application Publication
(10) Pub. No.: US 2021/0269100 A1
(43) Pub. Date: Sep. 2, 2021

(54) OFF-ROAD VEHICLE HOOD VENT COVERING FOR PROTECTING ENGINE COMPONENTS FROM MUD, WATER AND DEBRIS

(71) Applicant: Milton Mick Mininger, III, Spring Hill, FL (US)

(72) Inventor: Milton Mick Mininger, III, Spring Hill, FL (US)

(21) Appl. No.: 16/805,710

(22) Filed: Feb. 29, 2020

(51) Int. Cl. B62D 25/10; B60K 11/08

(52) U.S. Cl. CPC B62D 25/105; B60K 11/08

(57) ABSTRACT

A hood vent cover for off-road vehicles is provided. The hood vent cover facilitates heating and cooling of an off-road vehicle's engine but that also protects the engine components from mud, water, and debris.

### BACKGROUND OF THE INVENTION

The present invention relates to off-road vehicle equipment and, more particularly, to a hood vent cover for heating, cooling, and protecting engine components.

Mudding is an off-road motorsport popular in North America in which the goal is to drive a vehicle through a pit of mud. Mudding has grown from a backyard pastime to events that host upward of 40,000 people in a weekend.

However, the mud can seep into the engine compartment through the hood vents and wreck the mechanical or electrical components within the off-road vehicle's engine bay. For instance, if mud gets into the radiator fins it can cause cooling problems.

Currently, there are hood vent devices for off-road mudding vehicles, but they only vent the heat from the engine bay but leave the engine bay unprotected.

As can be seen, there is a need for a hood vent cover for facilitating heating and cooling of an off-road vehicle's engine but that also protects the engine components from mud, water, and debris. The present invention embodies a vent covering that has hardware to attach and detach to off-road vehicles for protection from mud, water, debris, or other elements, while also designed to aid in ventilation, heating and cooling of the vehicle. The vent covering (colloquially known as the “Safe Muddin cover”) is adapted to dissipate heat, insulate the vehicle from the cold, and protect the engine compartment as well as the components under the hood.

In colder climates, the vent covering aids in keeping the engine warm for cockpit heating purposes. In warm condition, the vent covering can be removed quickly and easily for ventilation. When the vehicle is participating in off-road motorsports where the hood of the vehicle may be partially submerged in mud or water, the present invention may be quickly snapped on to keep water, mud, debris, snow or whatever out of the engine bay.

### SUMMARY OF THE INVENTION

In one aspect of the present invention, an off-road vehicle hood vent covering system includes the following: a cover material dimensioned to overlay an arrangement of hood vents of an off-road vehicle; a plurality of first fasteners spaced apart along a periphery of a first side of the cover material; and a plurality of second fasteners spaced apart along a hood of the off-road vehicle so as to both align with the plurality of first fasteners and circumscribe said arrangement of hood vents, wherein the pluralities of first and second fasteners removably secure to each other.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a front elevation view of an exemplary embodiment of the present invention;

FIG. 3 is a perspective view of an exemplary embodiment of the present invention, shown in use;

FIG. 4 is an exploded perspective view of an exemplary embodiment of the present invention, shown in use; and

FIG. 5 is a detailed perspective view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hood vent cover designed for facilitating ventilation, heating, and cooling of an off-road vehicle's engine as well as being adapted to protect the engine components from mud, water, and debris.

It should be understood by those skilled in the art that the use of directional terms such as upper, lower, upward, downwardly, top, left, right and the like are used in relation to the illustrative embodiments as they are depicted in the figures, the upward direction (or upper) being toward the top of the corresponding figures, the downward direction being toward the bottom of the corresponding figures.

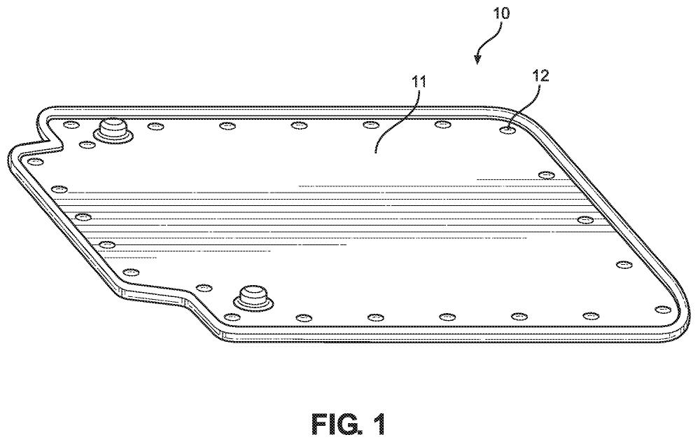

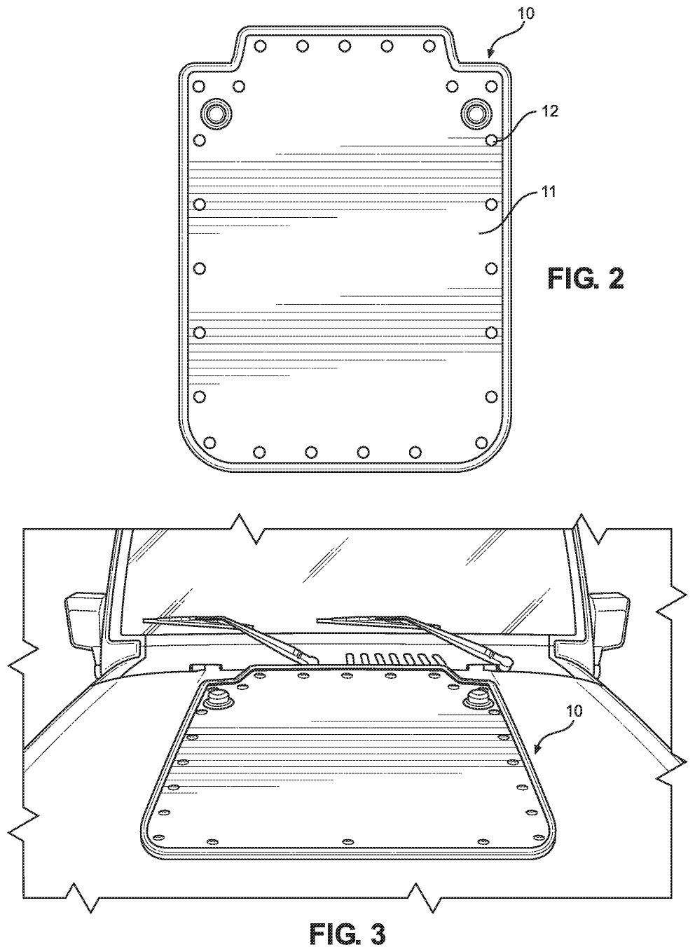

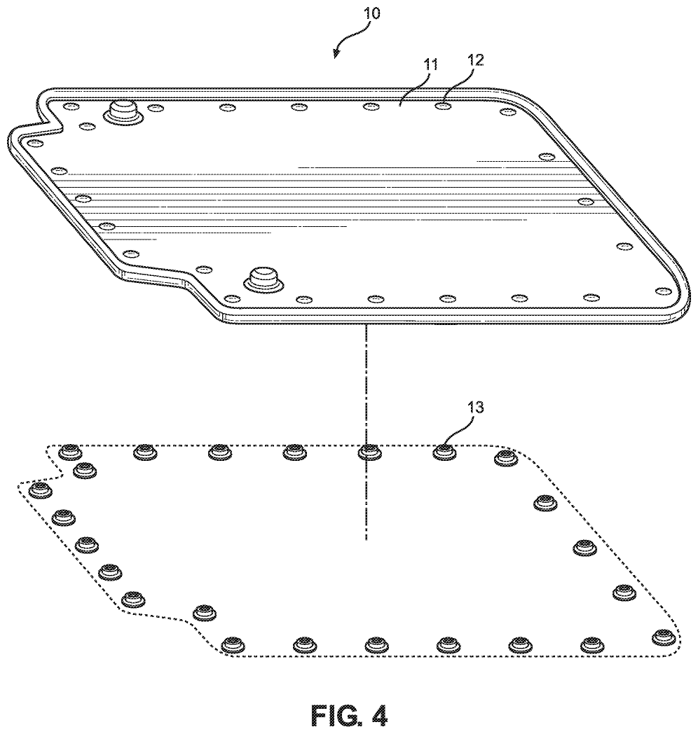

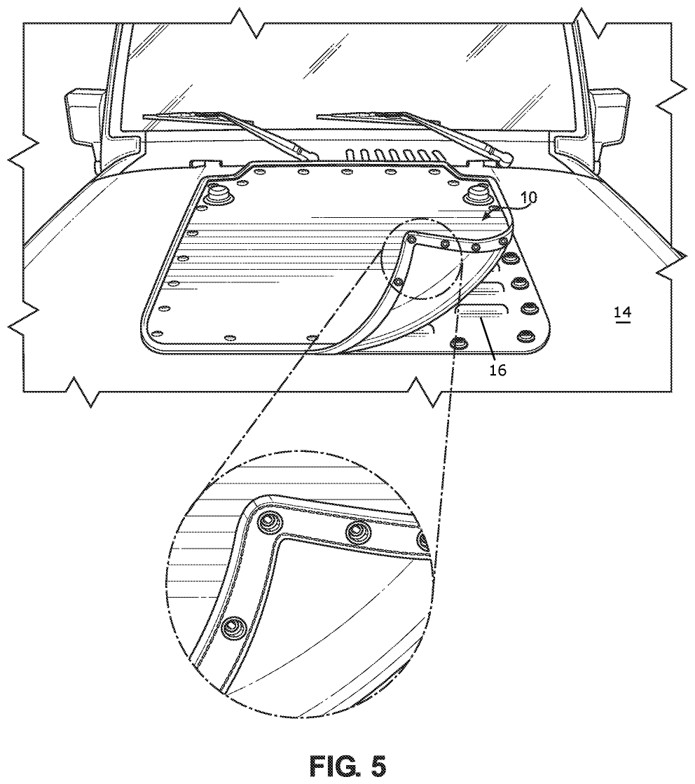

Referring to FIGS. 1 through 5, the present invention may include a venting cover 10 having a flat cover material 11, wherein a plurality of first fasteners 12 provided along a periphery of the cover material 11. The cover material 11 can be vinyl, marine canvas, various plasticized materials or any material that is durable and can be shaped to conform to the spacing and overall arrangement of hood vents 16 of off-road vehicles 14.

A method of installing the present invention includes adding a plurality of second fasteners 13 along an off-road vehicle 14 so that the second fasteners circumscribe the hood vents 16 thereof. The first and second fasteners 12 and 13 are adapted to removably attach to each other, such as snaps and rivets, by being in alignment.

A method of using the present invention may include the following. The venting cover 10 disclosed above may be provided. In cold conditions, days with inclement weather, or days when the driver of the vehicle 14 is going to engage in off-road motorsports, a user may attach the venting cover 10 by way of the first and second fasteners 12 and 13 so as to cover the hood vents 16 of the off-road vehicle 14. During hot conditions, the user may remove the venting cover 10.

The vent cover 10 can also be an aesthetically appealing accessory added any vehicle 14.

It should be understood, of course, that the foregoing relates to exemplary embodiments of the invention and that modifications may be made without departing from the spirit and scope of the invention as set forth in the following claims.

What is claimed is:

1. An off-road vehicle hood vent covering system, comprising:
a cover material dimensioned to overlay an arrangement of hood vents of an off-road vehicle;
a plurality of first fasteners spaced apart along a periphery of a first side of the cover material; and
a plurality of second fasteners spaced apart along a hood of the off-road vehicle so as to both align with the plurality of first fasteners and circumscribe said arrangement of hood vents, wherein the pluralities of first and second fasteners removably secure to each other.

2. The off-road vehicle hood vent covering system of claim 1, further comprising:
wherein each first fastener is a rivet and wherein each second fastener is a snap compatible with each rivet.
